(19) United States
(12) Patent Application Publication
(10) Pub. No.: US 2025/0299568 A1
(43) Pub. Date: Sep. 25, 2025

(54) SYSTEM AND METHOD FOR TRAFFIC SIGNAL CONTROL BY CLASSIFYING INTERSECTION CRASH RISK PRIORITY

(71) Applicant: DENSO International America, Inc., Southfield, MI (US)

(72) Inventors: Mahdi BANDEGI, Wixom, MI (US); Fatemeh MOUSAPOURSIAHGOURAB, Ann Arbor, MI (US); Rajesh MALHAN, Troy, MI (US)

(73) Assignee: DENSO International America, Inc., Southfield, MI (US)

(21) Appl. No.: 19/083,497

(22) Filed: Mar. 19, 2025

Related U.S. Application Data
(60) Provisional application No. 63/567,599, filed on Mar. 20, 2024.

(51) Int. Cl. G08G 1/081; G08G 1/01; G08G 1/16

(52) U.S. Cl. CPC G08G 1/081; G08G 1/0116; G08G 1/0129; G08G 1/166

(57) ABSTRACT

A traffic management system and method for operating the same includes a plurality of roadside devices associated a plurality of intersections comprising traffic lights and a control module. The control module is programmed to obtain data from the plurality of roadside devices to form trajectories. The control module is programmed to cluster intersections based on trajectories of road users to form a risk-safety score, optimize the intersections comprises optimizing intersection by generating a starting time and duration of traffic lights for the intersections based on the risk-safety score and communicate the start time and duration to the traffic lights. The traffic lights are controlled according to the start time and duration.

### CROSS-REFERENCE TO RELATED APPLICATION

This application claims the benefit of U.S. Provisional Application No. 63/567,599 filed on Mar. 20, 2024. The entire disclosure of the above application is incorporated herein by reference.

### TECHNICAL FIELD

The present disclosure relates to a traffic signal controls, and, more particularly, to a system and method for traffic signal control classifying intersection crash risk priority.

### BACKGROUND

This section provides background information related to the present disclosure which is not necessarily prior art.

Traffic signal optimization is of sufficient importance in addressing pervasive issues of traffic congestion in urban areas. As urbanization continues to grow, the demand for efficient transportation systems become increasingly critical. Traffic congestion not only results in extended travel times but also contributes to increased fuel consumption, elevated emissions and overall air quality decline. Traffic congestion also affects economic and social development of cities. To mitigate these challenges, optimizing traffic signals is a pivotal strategy.

By considering all the intersections as a system. Some intersections have more effect than others in the overall system.

Weights have been used in the past only to emphasize completed trips where the origin and destination are far apart such as 10 miles. The weights in the paper are lengths of the shortest-distance path from the origin to the destination of each trip and therefore the bias is for the shortest trips within the network.

### SUMMARY

This section provides a general summary of the disclosure and is not a comprehensive disclosure of its full scope or all of its features.

The present disclosure provides a system and method that uses weights that computed for each intersection based on a crash risk score from a clustering model and implemented to the objective function with the dilemma zone safety metrics and efficiency metrics. The efficiency metrics may measure the throughput or delay. The weights are an output of unsupervised learning clustering model which is derived by processing trajectories approaching all intersections and find similarity based on the road user trajectories and assigned crash risk score for each group of intersection.

In one aspect of the disclosure, a method for operating a traffic management system includes obtaining data from a plurality of sources associated with a roadway including a plurality of intersections to form trajectories, clustering intersections based on trajectories of road users to form a risk-safety score, optimizing the intersections by generating a starting time and duration of traffic lights for the intersections based on the risk-safety score, communicating the start time and duration to the traffic lights and controlling the traffic lights according to the start time and duration.

In another aspect of the disclosure, a traffic management system includes a plurality of roadside devices associated a plurality of intersections comprising traffic lights and a control module. The control module is programmed to obtain data from the plurality of roadside devices to form trajectories. The control module is programmed to cluster intersections based on trajectories of road users to form a risk-safety score, optimize the intersections comprises optimizing intersection by generating a starting time and duration of traffic lights for the intersections based on the risk-safety score and communicate the start time and duration to the traffic lights. The traffic lights are controlled according to the start time and duration.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1A is a functional diagram of a traffic management system according to the present disclosure.

FIG. 1B is a block diagram of a roadside device of FIG. 1A.

FIG. 1C is a block diagram of the vehicle of FIG. 1A.

FIG. 2 is a block diagrammatic view of the modules of the present disclosure.

FIG. 3 is a diagrammatic view of the preprocessing module 220.

FIG. 4 is a plot of an intersection crash risk score based on a clustering output.

Corresponding reference numerals indicate corresponding parts throughout the several views of the drawings.

### DETAILED DESCRIPTION

Example embodiments will now be described more fully with reference to the accompanying drawings.

Recent intelligent vehicles include various sensors and communication devices, which are used to understand host vehicle behavior, driver behavior, and behavior of other vehicles. Driver assistance is provided based on outputs of the sensors, current operating conditions, and a detected operating environment. For example, a steering wheel angle, a brake pedal position, and an accelerator pedal position may be monitored to determine driver behavior while external radar sensor signals and camera images may be monitored to detect a current vehicle environment, which may include other vehicles. As an example, location and movement of lane markers, surrounding objects, signal lights, etc. may be monitored. Driver assistance may be provided to, for example, autonomously steer, brake and/or decelerate the corresponding host vehicle to prevent a collision.

A modular artificial intelligence (AI) system of a vehicle may perform autonomous actions and operate a vehicle to, for example, merge from a first lane of traffic into a second lane of traffic. A modular AI system is an AI system that is applicable to various vehicle environments and follows a set of rules to predict movement (e.g., travel path, speed, acceleration, etc. of nearby vehicles relative to a host vehicle).

Autonomous driving in past years is a leading focus point in the automotive research field and driving in urban and highway traffic is complex. Given the statistics indicating that the number of fatalities in traffic accidents in the last 10 years is 1.2 million per year, autonomous driving is expected to save millions of lives in the future. Apart from orthodox techniques and in order to provide a vehicle with some self-built intelligence, several machine learning (ML) techniques have been introduced, which allow a driving agent to learn from gathered data and improve future operations based on determined experiences. A “driving agent” or “agent” as used herein may refer to a vehicle, a vehicle control module, a driver assistance module, a RLP module, a simulation system control module, a simulated vehicle control module, or other autonomous vehicle module. An agent may refer to a combination of two or more of the stated modules. Current autonomous methods include vehicle individualized intelligence without collaboration that focus operations based on sensory inputs.

The examples provided herein include collaborative multi-agent reinforcement learning. This may be implemented, for example, on a highway, freeway, roadway, or other multi-vehicle environment. The collaborative multi-agent reinforcement learning approach may also be implemented in an actual vehicle environment, in a simulated environment, or other multi-agent environment where multiple agents are able to interact. Each of the agents is able to learn behaviors of that agent and/or corresponding vehicle and behaviors of the other agents and/or corresponding vehicles. The stated behaviors are learned over time based on feedback data, sensor data, and shared data collected in association with different environment states and performed actions. Collaborative systems are disclosed in which the agents share data about the environment and decision making information and based on this information decide on a best course of action to take next. This includes avoiding obstacles, pedestrians and rogue vehicles, which may be un-instrumented and/or non-autonomous vehicles. This aids in preventing a collision. The collaborative systems include teaching agents to drive autonomously and collaboratively in certain scenarios, such as highway scenarios.

The disclosed agents perform collaborative decision making and path planning using trained and continuous learning artificial intelligence (AI) systems to prevent single and series collisions. A single collision refers to a collision between two vehicles. A series collision refers to a multiple consecutive collisions between more than two vehicles, sometimes referred to as a “traffic pile up”. Certain traffic conditions may be mixed such that the traffic includes autonomous vehicles, partially autonomous vehicles, and/or non-autonomous (manually driven) vehicles. Other traffic conditions may include only fully autonomous vehicles that are fully connected (i.e. able to communicate with each other and share information).

Roadside devices such as traffic signals may also be controlled and coordinated with the control of vehicles to reduce conflicts. By controlling timing, roadside devices can position traffic in a coordinated manner.

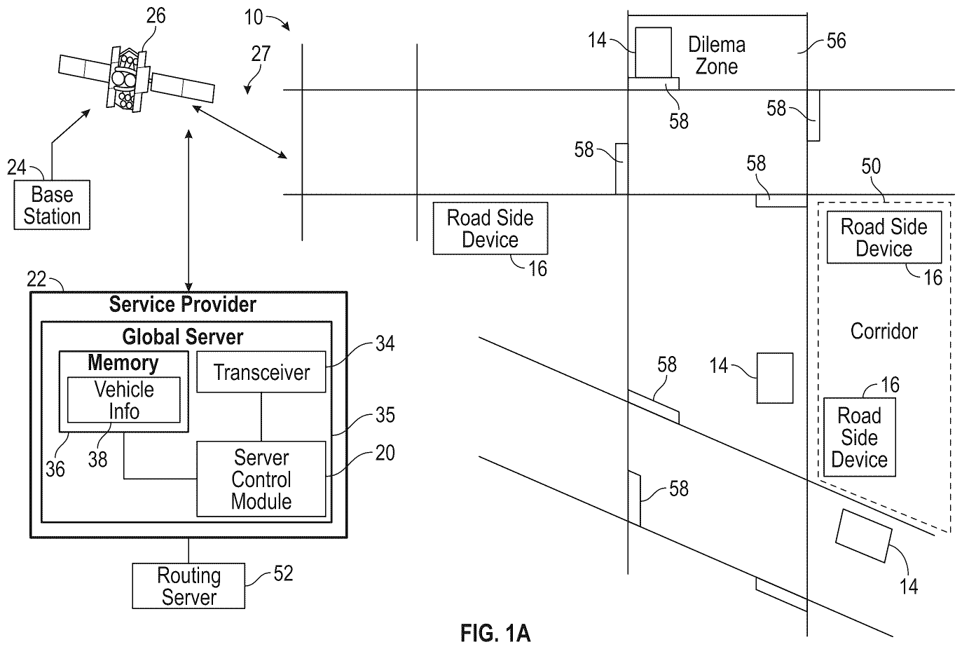

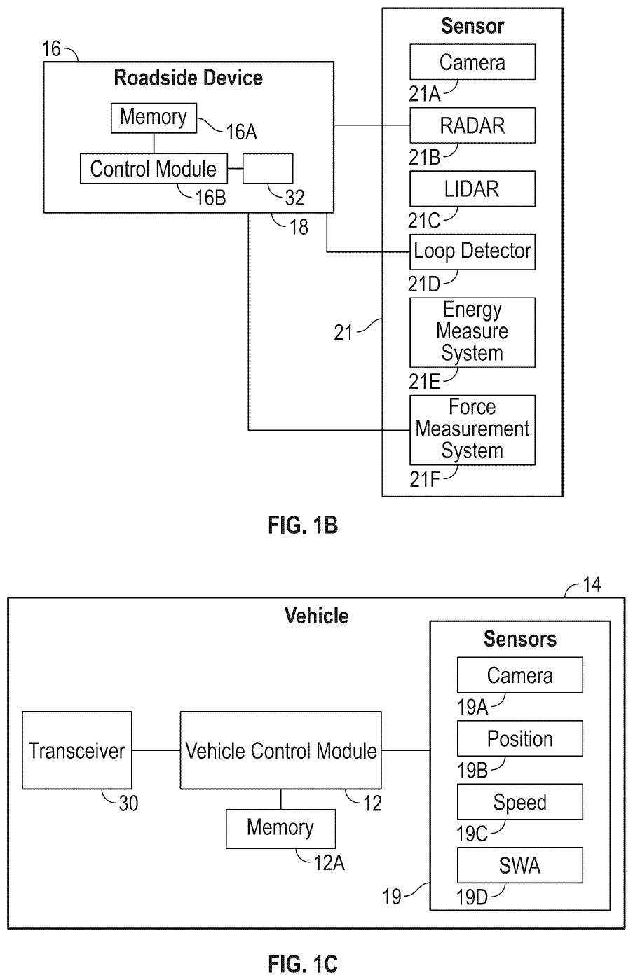

Referring to FIGS. 1A, 1B and 1C, a traffic management system 10 in a mixed autonomous operating environment is illustrated. The traffic management system 10 may include various vehicle communication devices (or devices that transmit vehicle related data or roadside device data), such as vehicle control modules 12 of vehicles 14, roadside control modules 16B of roadside units (or roadside devices) 16, a server control module 20 of a service provider 22, and/or other communication devices, such as vehicle communication devices or roadside devices in a base station 24 or a satellite 26 which form a communication network 27. The vehicle related information or data is obtained from the various sources and is processed together. The vehicle related information may include messages and/or signals including information pertaining to the vehicles 14 and/or objects within predetermined distances of the vehicles 14. As an example, the server 35 may be implemented as a cloud-based server and the server control module 20 may be implemented as a RLP module. A portion of and/or a version of the RLP algorithm described below may be implemented by each of the vehicle control modules 12, roadside control modules 16B, and the server control module 20. In addition, one or more levels of the RLP architecture disclosed herein may be implemented by the vehicle control modules 12, roadside control modules 16B, and the server control module 20.

The roadside device 16 may also include sensors 21 such as cameras 21A, radar 21B, lidar 21C, a pavement embedded loop detector 21D, energy measurement system 21E and force measurement system 21F. Loop detectors 21D are embedded in the road surface and capable of detecting stationary or slow-moving vehicles, making them suitable for traffic signal control and vehicle counting. Radar sensors 21B are mounted above the road on the traffic light or the light pole and capable of detecting moving vehicles, making them ideal for speed detection, traffic monitoring, and vehicle safety systems. The roadside devices 16 may be referred to as a “facility” and may be a traffic light or other device to aid vehicles.

The vehicles 14 include the vehicles control modules 12 and transceivers 30 for vehicle-to-vehicle communication and communication with the other vehicle communication devices, such as communication with transceivers 32,34 of the roadside devices 16 and the service provider 22. Vehicle 14 may also include sensors 19 such as cameras 19A or other devices to obtain geographic positions of objects, a position sensor 19B such as a global position sensor, a speed sensor 19C a steering wheel angle sensor 19D. The service provider 22 may include a global server 35, which includes the server control module 20, the transceiver 34, and a memory 36. The memory 36 may store vehicle information 38, such as that described herein, which may be shared with the vehicles 14. The control modules 12, 16B and 20 may be microprocessor-based and may be associated with respective memories 12A, 16A and 36. The memories are non-transitory computer-readable mediums that include machine readable instructions that are executable by the processor.

The roadside devices 16 may be coupled together and referred to as a corridor 50. Various roadside devices 16 may be grouped together in a corridor 50. That is, the roadside devices 16 may act together and therefore may not include a separate device rather operation may be controlled for each of the roadside devices within the corridor 50. For example, on a certain stretch of road, the traffic signals may be synchronized for a long distance. These synchronized traffic lights may be part of the same corridor 50. The corridors 50 may include their parameters collectively. The number of facilities and/or corridors that are in communication with the global server 35 may vary as well.

A routing server 52 may be coupled to the service provider 22. Emergency vehicles or other types of vehicles may be in communication with the routing server 52 to obtain a planned routes according to parameters within the global server 35. The routing server 52 may be incorporated within the service provider 22 although the routing server 52 is shown as a separate component. The routing server 52, the roadside devices 16 and the road users 14, all intercommunicated through various devices such as the base station 24 and/or the satellite 26.

A dilemma zone 56 is also illustrated in one position for simplicity. However, each intersection has a dilemma zone before a stop line 58. The dilemma zone 56 exists at a distance from the intersection or stop line 58 whereat upon actuation of the yellow signal; the motorist could conceivably either stop before the intersection/stop line 58 or proceed through it before the red light interval. Upon encountering a yellow signal in the dilemma zone, a motorist must decide in a few seconds or less whether to proceed or stop. The ability to stop or proceed on the yellow light is affected by the following in general casual, factors: the driver's reaction time; the vehicle's breaking performance; the speed of the vehicle; the vehicle acceleration performance; the road surface coefficient of friction (may be affected by weather); the proximity of following vehicle. All these factors must be quickly taken into account by the driver resulting in a decision if to stop prior intersection or to pass the intersection.

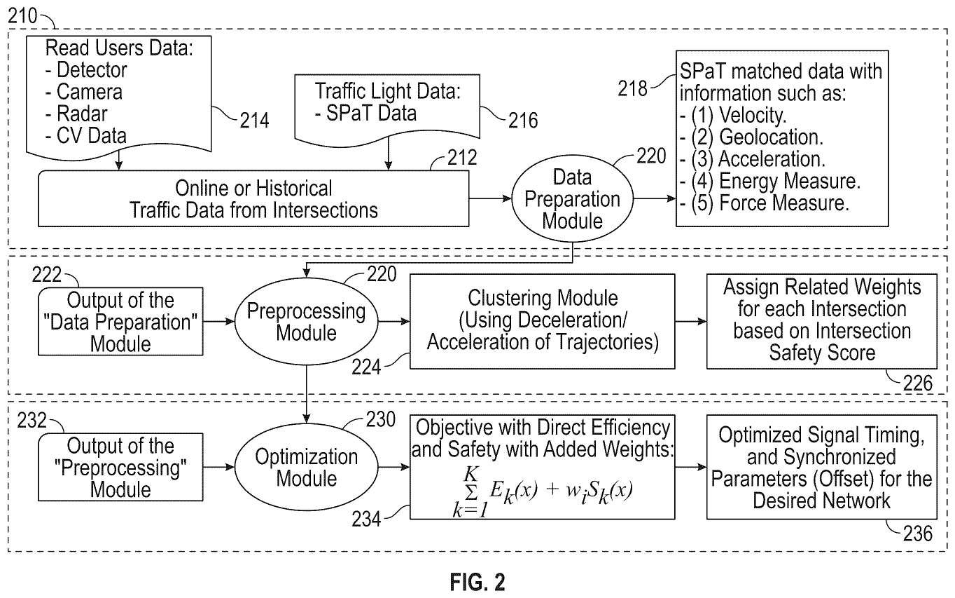

Referring now to FIG. 2, the operation of the traffic management system 10 may take place in the control module 20 of the service provider 22 which is programmed to perform various step and control the roadside devices such as traffic signals. In general, weights are computed for each intersection based on a crash risk score for a clustering model and is implemented to the objective function with the dilemma zone safety metric and efficiency metrics. Efficiency metrics may correspond to throughput or delays of the road users such as vehicles. The weights are the output of the unsupervised learning cluster model which is derived by processing trajectories approaching all intersections. Similarities are found based on the road user trajectories and are assigned crash risk scores for each group intersection. In FIG. 2, a data preparation module 210 is illustrated. The data preparation module may be part of the server control module 20 illustrated in FIG. 1A. The data preparation module 210 receives online or historical traffic data including historical traffic signal data from the intersections at block 212. The online or historical traffic data may be stored within the memory 36 of FIG. 1. The online or historical traffic data from the intersection may include various types of road user data such as loop detector data, camera data, radar data and connected vehicle data. The road user data 214 is generally illustrated in FIGS. 1A-1C. Road user data may correspond to the operation of a vehicle. Other data may include roadside device data 216 that may include signal phase and timing (SPaT) data. The signal phase and timing may include the start time, the duration and which signal (red, yellow, green) that are being operated. Ultimately, the data preparation module 20 aggregates and processes the data from the multiple sources such as the road user data 214 and the traffic light data 216. The data is coordinated by time and is therefore time dependent. The data represents the driving characteristics relating to trajectories of a vehicle. A trajectory is a position and past positions as well as predicted future positions of road user such as a vehicle. Trajectories have a velocity and acceleration (and negative acceleration, deceleration) Although vehicles are illustrated, road users may also include other types of users such as bicyclists, motorcyclists and pedestrians. Ultimately, the data may be matched with acquired data such as the velocity, the geolocation, the acceleration and energy measure and a force measure in block 218. Energy measurement and force measurement refer to specific types of calculated/analyzed data. From road user trajectory data (position, velocity, acceleration) and known/estimated parameters (mass, drag coefficient), the energy and forces measures are determined.

A preprocessing module 220 receives the output of the data preparation module 210 at block 222 has a clustering module 224 that may also be included within the server module 20 of FIG. 1A. The clustering module as will be described in greater detail uses deceleration and acceleration of trajectories in block 224 and assigns related weights for each intersection based on an intersection safety score in block 226. Essentially, the preprocessing module 220 finds similarity between the time series data. Approaching trajectories are grouped based on the similarity between pairwise trajectories situated in the dilemma zone 56. The dilemma zone 56 was described in greater detail relative to FIG. 1A.

In the last block of the traffic management system 10, an optimization module 230 obtains the output of the preprocessing module at block 232. At block 234, the optimization may take place using a mixed integer programming (MIP) system. The optimization takes place without the loss of generality of different weights related to driving characteristics implemented directly to the safety term in the objective function. Ultimately, the optimization module 230 generates an output signal that corresponds to traffic signal characteristics including but not limited to the starting time and duration for the red, green and yellow signal lights at each intersection which are communicated though each roadside device through the network 27 of FIG. 1A. Ultimately, the block 236 optimizes the signal timing and synchronize parameters for the entire network.

The objective function of block 234 is set forth below.

$$minimize F ( x ) = {\sum }_{k = 1}^{K} {E}_{k} ( x ) + {w}_{l} {S}_{k} ( x )$$

$$subject to$$

$$\begin{matrix}{g}_{j} ( x ) \geq 0 , & j = 1 , 2 , … , J \\ {h}_{m} ( x ) \geq 0 , & m = 1 , 2 , … , M \\ {x}_{i}^{( L )} \leq {x}_{i} \leq {x}_{i}^{( U )} , & i = 1 , 2 , … , n\end{matrix}$$

Where, K is the number of intersections within the network, which are grouped into L clusters.
Eₖ: Efficiency metric factor for each intersection within the network (such as delay, throughput, etc.)
Sₖ: Safety metric factor for each intersection within the network (such as distance travelled by vehicles within the dilemma zone during the yellow signal phase, number of dilemma zone encounters,
wₜ: Safety weights for intersection importance of each group of intersections (higher weights are related to intersections with higher crash risk), where, I is the cluster related to intersection k, determined at the preprocessing module 220
xᵢ: Variables such as cycle duration, offsets, and green time of each phase
gⱼ: Traffic flow constraints
hₘ: Traffic signal constraints.

The above equation explains the objective function and the constraints of the model. In the objective function, for each intersection within the network two metrics are related to vehicles approaching that intersection. First term considers efficiency of traffic flow (delay of vehicles), and the second term focuses on the safety which is the time travelled by vehicles approaching the intersection while the signal light is yellow in the dilemma zone. The optimization method finds the optimum traffic signal variables (green, red, and yellow timing, duration start of green, and offset) that minimizes the objective function, hence, enhancing both efficiency and safety of the network. Once communicated to roadside device, the traffic signal variables are used to control the traffic lights.

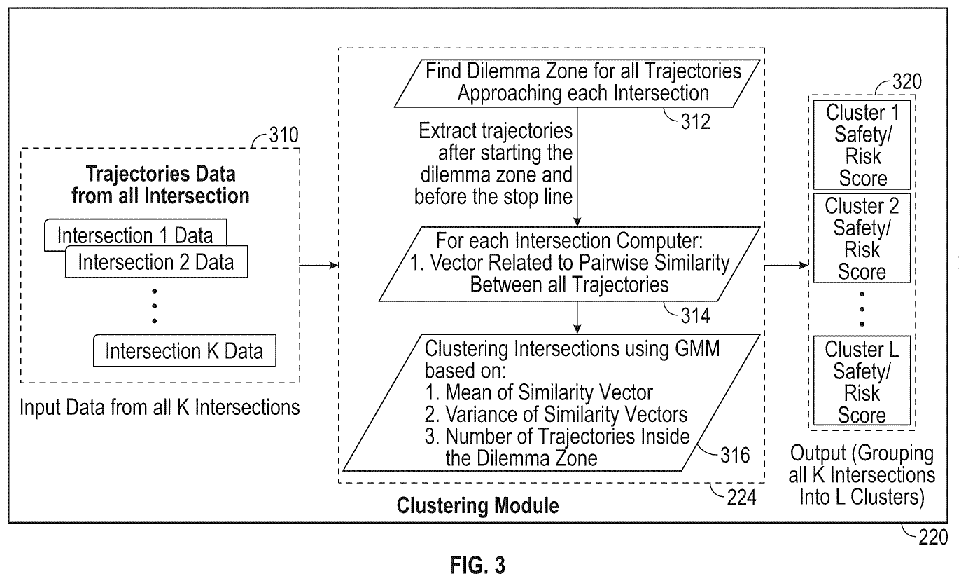

Referring now to FIG. 3, a flowchart for generating intersection clusters is set forth. Block 310 illustrates intersection data being obtained from all of the intersections. The data is described above and is not limited to roadside device data, vehicle date and connected vehicle data. The cluster module 224 is also illustrated in further detail. In block 224, step 312 finds the dilemma zone for all trajectories approaching each intersection. The trajectories are extracted after starting the dilemma zone but before the stop line. In step 314, the vectors related to the pairwise similarities between all of the trajectories are generated. This is a substantially amount of data that is computed for each of the intersections within the system. In step 316, the intersections are clustered using a Gaussian mixture module in this example. The Gaussian mixture model uses the mean of the similarity vector, the variance of the similarity vectors and the number of trajectories inside the dilemma zone to determine the cluster. Dynamic time warping may be applied to compare and find similarities between the pairwise time series data in step 314 and 316. The derive vector represents how similar driving behaviors are for trajectories that encounter the dilemma zone. Ultimately, the mean, variance and length related to all of the trajectories is obtained in step 316. The ultimate output in step 320 provides clusters for all of the intersections. In this example, K intersections are grouped into L clusters The output of the clustering module 224 is a probability of each cluster which is interpreted as a risk-safety score for each cluster.

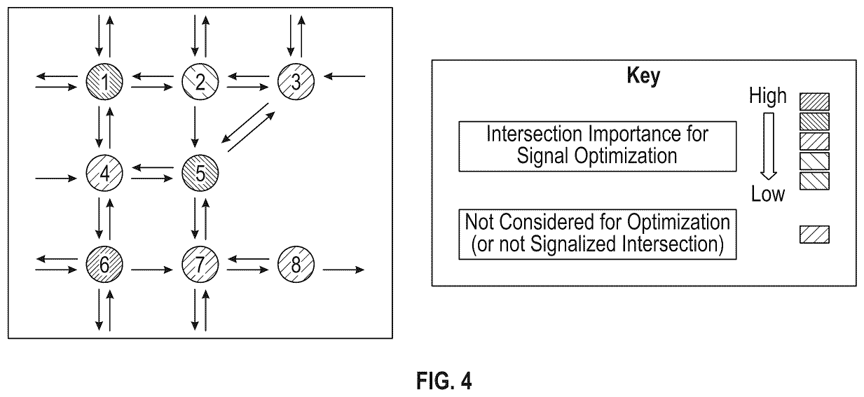

Referring now to FIG. 4, the output of the preprocessing module 220 is represented. Different groups of intersections based upon a safety score, or importance is used as an objective function. The darker shaded intersections have a higher risk and have been given a higher weight in the optimization by the formulas set forth above.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

As used herein, the phrase at least one of A, B, and C should be construed to mean a logical (A OR B OR C), using a non-exclusive logical OR. For example, the phrase at least one of A, B, and C should be construed to include any one of: (i) A alone; (ii) B alone; (iii) C alone; (iv) A and B together; (v) A and C together; (vi) B and C together; (vii) A, B, and C together. The phrase at least one of A, B, and C should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set. In this application, including the definitions below, the term “module” or the term “controller” may be replaced with the term “circuit.” The term “module” or the term “controller” may refer to, be part of, or include processor hardware (shared, dedicated, or group) that executes code and memory hardware (shared, dedicated, or group) that stores code executed by the processor hardware.

The module or controller may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module or controller may communicate with other modules or controllers using the interface circuit(s). Although the module or controller may be depicted in the present disclosure as logically communicating directly with other modules or controllers, in various implementations the module or controller may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module or controller may be distributed among multiple modules that are connected via the communications system. For example, multiple modules may implement the same functionality distributed by a load balancing system. In a further example, the functionality of the module or controller may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules or controllers. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective C, Swift, Haskell, Go, SQL, R, Lisp, Java®, Fortran, Perl, Pascal, Curl, Ocaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A method for operating a traffic management system comprising:
obtaining data from a plurality of sources associated with a roadway including a plurality of intersections to form trajectories of road user;
clustering intersections based on trajectories of road users to form a risk-safety score for each intersection;
optimizing the intersections by generating a starting time and duration of traffic lights for the intersections based on the risk-safety score for each intersection;
communicating the start time and duration to the traffic lights; and
controlling the traffic lights at each intersection according to the start time and duration.

2. The method of claim 1 wherein obtaining data from a plurality of sources comprises obtaining camera data, radar data and connected vehicle data.

3. The method of claim 1 wherein obtaining data comprises acquiring velocity, acceleration, energy measure, force measurement and geolocations.

4. The method of claim 1 wherein obtaining data comprises historical traffic signal phase and timing data for the intersections.

5. The method of claim 1 wherein clustering comprises clustering based on time associated with the trajectories of road users.

6. The method of claim 1 wherein clustering comprises associating a dilemma zone with each intersection and wherein the road user trajectories are within the dilemma zone.

7. The method of claim 1 wherein clustering comprises determining, for each intersection, vectors related to pairwise similarities for all trajectories.

8. The method of claim 7 wherein clustering comprises clustering the intersections using a mean, variance and length of the vectors.

9. The method of claim 7 wherein clustering comprises determining a probability as the risk-safety score.

10. The method of claim 9 wherein clustering comprises generating a weight for the risk-safety score for each group of intersections.

11. The method of claim 10 wherein optimizing comprises generating an efficiency metric factor for each intersection, and a safety metric factor weighted by the weight for each intersection.

12. The method of claim 11 wherein generating the efficiency metric factor and the safety metric factor comprises generating the efficiency metric factor corresponding to delay, throughput and the safety metric factor based on distance travelled by vehicle in a dilemma zone on a yellow signal phase.

13. A traffic management system comprising:
a plurality of roadside devices associated a plurality of intersections comprising traffic lights;
a control module programmed to
obtain data from the plurality of roadside devices to form trajectories of road users;
cluster intersections based on trajectories of road users to form a risk-safety score for each intersection;
optimize the intersections comprises optimizing intersection by generating a starting time and duration of traffic lights for the intersections based on the risk-safety score;
communicate the start time and duration to the traffic lights; and
the traffic lights being programmed to be controlled according to the communicated start time and duration.

14. The traffic management system of claim 13 wherein the data comprises camera data, radar data, connected vehicle data.

15. The traffic management system of claim 13 wherein the data comprises a velocity, acceleration, energy measure, force measurement, geolocations, historical traffic signal phase and timing data for the intersections.

16. The traffic management system of claim 13 wherein clustering comprises associating a dilemma zone with each intersection and wherein the road user trajectories are within the dilemma zone.

17. The traffic management system of claim 13 wherein the control module is programmed to determine for each intersection, vectors related to pairwise similarities for all trajectories.

18. The traffic management system of claim 13 wherein the risk-safety score is associated with a weight for each group of intersections.

19. The traffic management system of claim 18 wherein optimizing comprises generating an efficiency metric factor for each intersection, and a safety metric factor weighted by the weight for each intersection.

20. The traffic management system of claim 19 wherein the control module is programmed to generates the efficiency metric factor and the safety metric factor comprises generating the efficiency metric factor corresponding to delay, throughput and the safety metric factor based on distance travelled by vehicle in a dilemma zone on a yellow signal phase.
